(19) United States
(12) Patent Application Publication
(10) Pub. No.: US 2025/0079036 A1
(43) Pub. Date: Mar. 6, 2025

(54) Conductive Color Coatings

(71) Applicant: Apple Inc., Cupertino, CA (US)

(72) Inventors: Richard K Akrobetu, San Carlos, CA (US); Jozef M Matlak, San Francisco, CA (US); Shinjita Acharya, Santa Clara, CA (US); Brian S Tryon, Redwood City, CA (US)

(21) Appl. No.: 18/524,120

(22) Filed: Nov. 30, 2023

Related U.S. Application Data
(60) Provisional application No. 63/580,274, filed on Sep. 1, 2023.

(51) Int. Cl. H01B 1/04; H01R 13/03

(52) U.S. Cl. CPC H01B 1/04; H01R 13/03

(57) ABSTRACT

An electronic device such as a power charger may include a conductive contact that conveys power signals. A coating may have adhesion and transition layers on the contact. The coating may have a thin-film interference filter having an uppermost layer that includes diamond-like carbon (DLC). If desired, the thin-film interference filter may have additional DLC layers stacked under the uppermost layer. The DLC layer(s) may include nitrogen to optimize corrosion resistance. The DLC layer(s) may include first and second metal dopants such as tungsten and chromium to optimize the electrical resistance and conductivity of the coating. The coating may exhibit a deep black, grey, and/or blue color.

This application claims the benefit of U.S. Provisional Patent Application No. 63/580,274, filed Sep. 1, 2023, which is hereby incorporated by reference herein in its entirety.

### FIELD

This disclosure relates generally to coatings for electronic device structures and, more particularly, to visible-light-reflecting coatings for conductive electronic device structures.

### BACKGROUND

Electronic devices such as cellular telephones, computers, watches, and other devices contain conductive structures such as conductive housing structures. The conductive structures are provided with a coating that reflects particular wavelengths of light so that the conductive structures exhibit a desired visible color.

It can be challenging to provide coatings such as these with a desired color response. In addition, if care is not taken, the coatings can undesirably deteriorate the electrical performance of the electronic device.

### SUMMARY

An electronic device may include conductive structures such as a conductive contact for transmitting or receiving power signals for an external device. A visible-light-reflecting coating may be disposed on the conductive contact.

The visible-light-reflecting coating may have adhesion and transition layers on the conductive contact. The coating may optionally have one or more opaque coloring layers on the adhesion and transition layers. The coating may have a thin-film interference filter on the opaque coloring layer(s) or the adhesion and transition layers. The thin-film interference filter may have an uppermost layer that includes diamond-like carbon (DLC). If desired, the thin-film interference filter may have additional DLC layers stacked under the uppermost layer.

The DLC layer(s) may include nitrogen to optimize the corrosion resistance of the coating. The DLC layer(s) may include first and second metal dopants such as tungsten and chromium. If desired, the DLC layer(s) may include a third metal dopant such as titanium. The metal dopants may optimize the electrical resistance and conductivity of the coating, thereby allowing the coating to convey the power signals for the underlying conductive contact. The coating may exhibit a deep black, grey, and/or blue color.

An aspect of the disclosure provides an apparatus. The apparatus may include a conductive substrate. The apparatus may include a coating on the conductive substrate and having a color. The coating may include adhesion and transition layers. The coating may include a diamond-like carbon (DLC) layer on the adhesion and transition layers, wherein the DLC layer comprises a metal dopant.

An aspect of the disclosure provides an apparatus. The apparatus may include a conductive substrate. The apparatus may include a coating on the conductive substrate and having a color. The coating may include adhesion and transition layers. The coating may include a thin-film interference filter on the adhesion and transition layers, the thin-film interference filter having a layer that includes diamond-like carbon (DLC), a first metal, a second metal, and nitrogen.

An aspect of the disclosure provides an electronic device. The electronic device can include a conductive contact configured to convey power signals. The electronic device can include a coating on the conductive contact and having a color. The coating can include adhesion and transition layers on the conductive contact. The coating can include a first diamond-like carbon (DLC) layer on the adhesion and transition layers. The coating can include a chromium carbide (CrC) layer on the first DLC layer. The coating can include a second DLC layer on the CrC layer, wherein the first DLC layer and the second DLC layer are each doped with a first metal and a second metal different from the first metal.

### BRIEF DESCRIPTION OF THE DRAWINGS

FIG. 1 is a perspective view of an illustrative electronic device of the type that may be provided with conductive structures and visible-light-reflecting conductive coatings in accordance with some embodiments.

FIG. 2 is cross-sectional side view of illustrative electronic devices having conductive structures that may be provided with visible-light-reflecting conductive coatings in accordance with some embodiments.

FIG. 3 is a cross-sectional side view of an illustrative visible-light-reflecting conductive coating having a thin-film interference filter with an uppermost diamond-like carbon (DLC) layer in accordance with some embodiments.

FIG. 4 is a cross-sectional side view of illustrative layers in a visible-light-reflecting conductive coating having a thin-film interference filter with two DLC layers in accordance with some embodiments.

FIG. 5 is a cross-sectional side view of illustrative layers in a visible-light-reflecting conductive coating having a thin-film interference filter with three DLC layers in accordance with some embodiments.

FIG. 6 is a cross-sectional side view of illustrative layers in a visible-light-reflecting conductive coating having a single DLC layer with two metal dopants in accordance with some embodiments.

FIG. 7 is a cross-sectional side view of illustrative layers in a visible-light-reflecting conductive coating having a single DLC layer with three metal dopants in accordance with some embodiments.

FIG. 8 is a ternary phase diagram of an illustrative DLC layer in a visible-light-reflecting conductive coating in accordance with some embodiments.

FIG. 9 is a plot showing how adding metal dopants to an illustrative DLC layer may minimize resistivity of a corresponding visible-light-reflecting conductive coating in accordance with some embodiments.

### DETAILED DESCRIPTION

Electronic devices and other items may be provided with conductive structures. The conductive structures may include a conductive contact that conveys power signals. A coating may be formed on the conductive contact to reflect particular wavelengths of visible light so that the conductive contact exhibits a desired color (e.g., a deep black, grey, and/or blue color). The coating may include adhesion and transition layers on the conductive contact, one or more optional opaque coloring layers on the adhesion and transition layers, and a thin-film interference filter on the opaque coloring layer(s). The thin-film interference filter may have an uppermost diamond-like carbon (DLC) layer, a chromium carbide (CrC) layer, and optionally one or more additional DLC layers. The DLC layer(s) may be doped with first and second metal dopants to maximize the electrical conductivity of the coating.

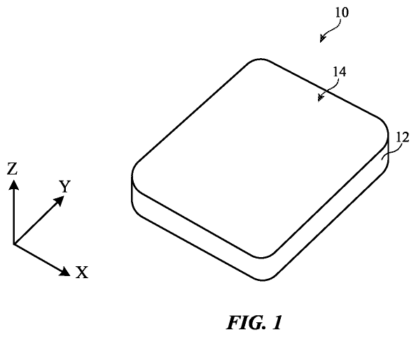

An illustrative electronic device of the type that may be provided with conductive structures and visible-light-reflecting conductive coatings is shown in FIG. 1. Electronic device 10 of FIG. 1 may be a computing device such as a laptop computer, a computer monitor containing an embedded computer, a tablet computer, a cellular telephone, a media player, or other handheld or portable electronic device, a smaller device such as a wristwatch device (e.g., a watch with a wrist strap), a pendant device, a headphone or earpiece device, a device embedded in eyeglasses or other equipment worn on a user's head (e.g., a head mounted device), or other wearable or miniature device, a television, a computer display that does not contain an embedded computer, a gaming device, a navigation device, an embedded system such as a system in which electronic equipment with a display is mounted in a kiosk or automobile, a wireless base station, a home entertainment system, a wireless speaker device, a wireless access point, a charging or powering device (e.g., a wired and/or wireless charger, adapter, and/or plug), equipment that implements the functionality of two or more of these devices, or other electronic equipment. The example of FIG. 1 is merely illustrative and, in general, device 10 may have other form factors.

In the example of FIG. 1, device 10 includes a display such as display 14. Display 14 may be mounted in a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.). Housing 12 may have metal sidewalls or sidewalls formed from other materials. Examples of metal materials that may be used for forming housing 12 include stainless steel, aluminum, silver, gold, titanium, metal alloys, or any other desired conductive material.

Display 14 may be formed at (e.g., mounted on) the front side (face) of device 10. Housing 12 may have a rear housing wall on the rear side (face) of device 10 that opposes the front face of device 10. Conductive housing sidewalls in housing 12 may surround the periphery of device 10. The rear housing wall of housing 12 may be formed from conductive materials and/or dielectric materials.

The rear housing wall of housing 12 and/or display 14 may extend across some or all of the length (e.g., parallel to the X-axis of FIG. 1) and width (e.g., parallel to the Y-axis) of device 10. Conductive sidewalls of housing 12 may extend across some or all of the height of device 10 (e.g., parallel to Z-axis). In implementations where device 10 is a laptop computer, housing 12 may include an upper housing that contains display 14 and a lower housing that contains a keyboard, trackpad, and/or other user input devices and that contains a power receiving port (e.g., a charging port or socket) that receives a corresponding charging plug. The lower housing may be coupled to the upper housing by a hinge and may rotate about the hinge with respect to the upper housing (e.g., between an open position and a closed position).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode (OLED) display pixels, an array of electrowetting display pixels, or display pixels based on other display technologies.

Display 14 may be protected using a display cover layer. The display cover layer may be formed from a transparent material such as glass, plastic, sapphire or other crystalline dielectric materials, ceramic, or other clear materials. The display cover layer may extend across substantially all of the length and width of device 10, for example. Alternatively, display 14 may be omitted from device 10 (e.g., device 10 need not include a display).

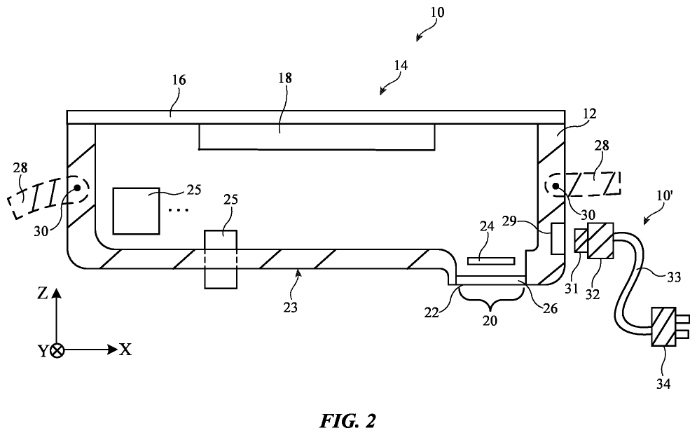

A cross-sectional side view of device 10 in an illustrative configuration in which display 14 has a display cover layer is shown in FIG. 2. As shown in FIG. 2, display 14 may have one or more display layers that form pixel array 18. During operation, pixel array 18 forms images for a user in an active area of display 14. Display 14 may also have inactive areas (e.g., areas along the border of pixel array 18) that are free of pixels and that do not produce images. Display cover layer 16 of FIG. 2 overlaps pixel array 18 in the active area and overlaps electrical components in device 10.

Display cover layer 16 may be formed from a transparent material such as glass, plastic, ceramic, or crystalline materials such as sapphire. Display cover layer 16 for display 14 may be planar or curved and may have a rectangular outline, a circular outline, or outlines of other shapes. If desired, openings may be formed in the display cover layer. For example, an opening may be formed in the display cover layer to accommodate a button, a speaker port, or other component. Openings may be formed in housing 12 to form communications or data ports (e.g., an audio jack port, a digital data port, a port for a subscriber identity module (SIM) card, etc.), to form openings for buttons, to form audio ports (e.g., openings for speakers and/or microphones), to form a power receiving port (e.g., a charging port), etc.

Device 10 may, if desired, be coupled to a strap such as strap 28 (e.g., in scenarios where device 10 is a wristwatch device). Strap 28 may be used to hold device 10 against a user's wrist (as an example). In the example of FIG. 2, wrist strap 28 is connected to attachment structures 30 in housing 12 at opposing sides of device 10. Attachment structures 30 may include lugs, pins, springs, clips, brackets, and/or other attachment mechanisms that configure housing 12 to receive wrist strap 28. Configurations that do not include straps may also be used for device 10.

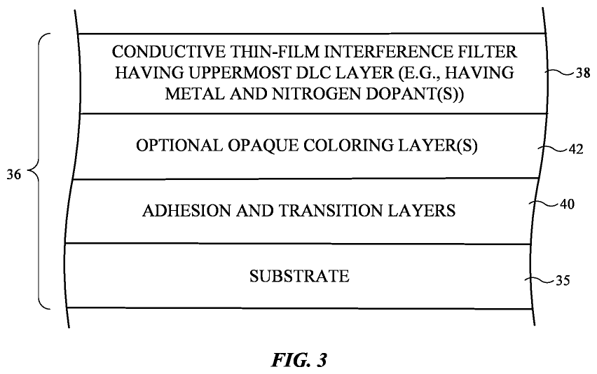

If desired, light-based components such as light-based components 24 may be mounted in alignment with an opening 20 in housing 12. Opening 20 may be circular, may be rectangular, may have an oval shape, may have a triangular shape, may have other shapes with straight and/or curved edges, or may have other suitable shapes (outlines when viewed from above). Window member 26 may be mounted in window opening 20 of housing 12 so that window member 26 overlaps component 18. A gasket, bezel, adhesive, screws, or other fastening mechanisms may be used in attaching window member 26 to housing 12. Surface 22 of window member 26 may lie flush with exterior surface 23 of housing 12, may be recessed below exterior surface 23, or may, as shown in FIG. 3, be proud of exterior surface 23 (e.g., surface 22 may lie in a plane that protrudes away from surface 23 in the −Z direction). In other words, window member 26 may be mounted to a protruding portion of housing 12. Surface 23 may, for example, form the rear face of housing 12. Opening 20 and/or light-based components 24 may be omitted if desired.

In implementations where device 10 is a laptop computer, the housing 12 shown in FIG. 2 may be a lower housing of the laptop computer (e.g., containing a keyboard and/or track pad without display 14) or may be an upper housing of the laptop computer (e.g., containing display 14). The lower housing may be coupled to the upper housing by a hinge (e.g., at the location of one of the attachment structures 30 shown in FIG. 2).

If desired, device 10 may be a powering or charging device such as charging device 10′ (e.g., a power charger). Charging device 10′ may include an adapter 34. Adapter 34 may be plugged into a wall outlet or other source of alternating current (AC) or direct current (DC) power. Adapter 34 may include an AC-DC power converter and/or other power adapter/converter circuitry enclosed within a corresponding housing. The housing may be formed from conductive structures or materials (e.g., metal) and/or dielectric materials (e.g., plastic, ceramic, etc.).

Adapter 34 may also include a plug 32 coupled to adapter 34 over cable 33. Plug 32 may be plugged/inserted into a corresponding charging port 29 (sometimes referred to herein as power receiving port 29 or power port 29) on an external device such as device 10. When plug 32 is plugged into charging port 29 and adapter 34 is plugged into a power source (e.g., a wall outlet, a power strip, etc.), adapter 34 receives power from the power source, converts the received power, and transmits the converted power to plug 32. Plug 32 includes conductive contacts 31 (e.g., power and ground pins) that contact (e.g., mate with) corresponding contacts in charging port 29 (e.g., power and/or ground contacts, pads, receptacles, etc.) when plug 32 is plugged into charging port 29. Charging device 10′ then delivers power to device 10 via charging port 29 to charge a battery on device 10 and/or to power components in device 10.

Power contacts 31 are formed from conductive structures such as metal structures (e.g., metal pins, contacts, pads, prongs, springs, etc.). Plug 32 may have a housing. The housing may enclose and/or include conductive contacts 31. The housing may, if desired, be formed from conductive structures such as metal walls. If desired, plug 32 and/or charging port 29 may include one or more magnetic structures (e.g., magnets) that help to snap, hold, or lock plug 32 in place (e.g., with conductive contacts 31 in contact with corresponding power contacts in charging port 29). The magnetic structures may, if desired, be configured to allow plug 32 to be easily removed from charging port 29 in response to greater than a threshold amount of force applied to charging device 10′, such as when a user accidentally moves, pulls, or trips on cable 33. This may help to prevent device 10 from sliding off an underlying surface and being damaged when the force is applied to charging device 10′.

Conductive structures in device 10 and/or charging device 10′ may be provided with a visible-light-reflecting coating that reflects certain wavelengths of light so that the conductive structures exhibit a desired aesthetic appearance (e.g., a desired color, reflectivity, etc.). The conductive structures in device 10 may include, for example, conductive portions of housing 12 (e.g., conductive sidewalls for device 10, a conductive rear wall for device 10, a protruding portion of housing 12 used to mount window member 26, etc.), attachment structures 30, conductive portions of wrist strap 28, a conductive mesh, conductive components 25, charging port 29, and/or any other desired conductive structures on device 10. Conductive components 25 may include internal components (e.g., internal housing members, a conductive frame, a conductive chassis, a conductive support plate, conductive brackets, conductive clips, conductive springs, input-output components or devices, etc.), components that lie both at the interior and exterior of device 10 (e.g., a conductive SIM card tray or SIM card port, a data port, a microphone port, a speaker port, a conductive button member, a power transfer port such as charging port 29, etc.), components that are mounted at the exterior of device 10 (e.g., conductive portions of strap 28 such as a clasp for strap 28), and/or any other desired conductive structures on device 10. The conductive structures in charging device 10′ may include some or all of plug 32 (e.g., a metal housing for plug 32), conductive contacts 31, cable 33 (e.g., a metal sheath, braid, or housing that runs along the length of cable 33 and that surrounds one or more power and/or ground lines coupled between conductive contacts 31 and adapter 34), and/or some or all of adapter 34 (e.g., a metal housing for adapter 34). If desired, data signals may also be conveyed over charging port 29.

It may be desirable for the visible-light-reflecting coating on one or more of the conductive structures of device 10 and/or charging device 10′ to be conductive (e.g., to exhibit less than a threshold electrical resistance). This may, for example, allow the underlying conductive structure to transmit and/or receive signals (e.g., power, radio-frequency signals, control signals, data signals, etc.) with other components while still exhibiting a desired color response and appearance. For example, a conductive visible-light-reflecting coating may be provided on the conductive structures of charging port 29 of device 10 (e.g., power and/or ground contacts within charging port 29) and/or the conductive structures of plug 32 on charging device 10′ (e.g., conductive contacts 31). The conductive visible-light-reflecting coating may configure charging port 29 and plug 32 to exhibit a desired color response and thus a desired uniform aesthetic appearance. At the same time, the conductive visible-light-reflecting coating may still allow power signals to be conveyed between charging device 10′ and device 10 with minimal electrical effect on the power signals.

FIG. 3 is a cross-sectional diagram of a conductive visible-light-reflecting coating that may be provided on a conductive structure in device 10 and/or charging device 10′. As shown in FIG. 3, a conductive visible-light-reflecting coating such as coating 36 may be disposed (e.g., deposited, layered, formed, etc.) on an underlying conductive substrate such as substrate 35. Substrate 35 may be a conductive structure in device 10 or charging device 10′ such as a conductive component 25, a conductive portion of housing 12 (FIGS. 1 and 2), a conductive portion of plug 32 (e.g., conductive contacts 31), a conductive portion of adapter 34, a conductive portion of cable 33, a conductive portion of charging port 29, etc.

Substrate 35 may be thicker than coating 36. The thickness of substrate 35 may be 0.1 mm to 5 mm, more than 0.3 mm, more than 0.5 mm, between 5 mm and 20 mm, less than 5 mm, less than 2 mm, less than 1.5 mm, or less than 1 mm (as examples). Substrate 35 may include stainless steel, aluminum, titanium, or other metals or alloys.

Coating 36 may include adhesion and transition layers 40 on substrate 35. If desired, coating 36 may include one or more optional opaque color layers 42 on adhesion and transition layers 40. Opaque color layers 42 may include a single layer, may include multiple layers, or may be omitted if desired. Coating 36 may include a thin-film interference filter such as thin-film interference filter (TFIF) 38 on opaque color layer 42.

Opaque color layer(s) 42 may, for example, have a first lateral surface that directly contacts adhesion and transition layers 40 and may have a second lateral surface opposite the first lateral surface. Thin-film interference filter 38 may, for example, have a third lateral surface that directly contacts the second lateral surface (or adhesion and transition layers 40 when opaque color layer(s) 42 are omitted) and may have a fourth lateral surface opposite the third lateral surface (e.g., the fourth lateral surface may form an uppermost or outermost surface of coating 36). Thin-film interference filter 38 may include multiple layers (films) stacked on opaque color layer(s) 42 (or adhesion and transition layers 40 when opaque color layer(s) 42 are omitted). In some implementations, thin-film interference filter 38 may include two stacked layers (films). In other implementations, thin-film interference filter 38 may include three or more stacked layers (films) or a single layer (film).

The layers of coating 36 may be deposited on substrate 35 using any suitable deposition techniques. Examples of techniques that may be used for depositing the layers in coating 36 include physical vapor deposition (PVD) (e.g., evaporation and/or sputtering), cathodic arc deposition, chemical vapor deposition, ion plating, laser ablation, etc. For example, coating 36 may be deposited on substrate 35 in a deposition system having deposition equipment (e.g., a cathode). Substrate 35 may be moved (e.g., rotated) within the deposition system while the deposition equipment (e.g., the cathode) deposits the layers of coating 36. If desired, substrate 35 may be moved/rotated dynamically with respect to speed and/or orientation relative to the deposition equipment (e.g., the cathode) during deposition. This may help provide coating 36 with as uniform a thickness as possible across its area, even in scenarios where substrate 35 has a three-dimensional shape.

Thin-film interference filter 38 may be formed from a stack of layers of material such as inorganic and/or organic dielectric layers with different refractive indices. The layers of thin-film interference filter 38 may include one or more layers having higher index of refraction values (sometimes referred to as “high” index values) and one or more layers having lower index of refraction values (sometimes referred to as “low” index values). The layers having higher index of refraction values may be interleaved with the layers having lower index of refraction values if desired.

Incident light may be transmitted through each of the layers in thin-film interference filter 38 while also reflecting off the interfaces between each of the layers, as well as at the interface between the thin-film interference filter and opaque color layer(s) 42 (or between thin-film interference filter 38 and adhesion and transition layers 40) and at the interface between thin-film interference filter 38 and air. By controlling the thickness and index of refraction (e.g., composition) of each layer in thin-film interference filter 38, the light reflected at each interface may destructively and/or constructively interfere at a selected set of wavelengths such that reflected light that passes out of the thin-film interference filter 38 is perceived by an observer with a desired color and brightness across a corresponding range of viewing angles (angles of incidence, e.g., from 0 to 60 degrees relative to a normal axis of the conductive structure), while also exhibiting a response that is relatively invariant across the lateral area of the coating even when deposited onto an underlying substrate 35 having a three-dimensional (e.g., curved) shape.

Unlike the layers of thin-film interference filter 38, opaque color layers such as opaque color layer(s) 42 are substantially opaque and do not transmit light incident upon coating 36. On the other hand, opaque color layer(s) 42 may reflect incident light received through thin-film interference filter 38 back towards and through thin-film interference filter 38. The thickness and/or composition of opaque color layer(s) 42 may contribute to the color response of the light upon exiting coating 36 as viewed by a user (e.g., in combination with the interference effects imparted to the transmitted and reflected light by thin-film interference filter 38). Opaque color layer(s) 42 may sometimes also be referred to herein as non-interference filter layer(s) or intrinsic color layer(s).

Thin-film interference filter 38 may be provided with an uppermost diamond-like carbon (DLC) layer (e.g., the uppermost layer of thin-film interference filter 38 may be a DLC layer). Thin-film interference filter 38 may include a single DLC layer, two DLC layers, three DLC layers, or more than three DLC layers. The DLC layer(s) in thin-film interference filter 38 may help to decrease the electrical resistance and therefore increase the electrical conductivity of coating 36 (e.g., may configure thin-film interference filter 38 to be a conductive thin-film interference filter). If desired, the DLC layer(s) may be provided with nitrogen (N₂) molecules during deposition. The nitrogen (N) included in the DLC layer(s) may help to maximize the corrosion resistance of coating 36, for example.

In addition, the DLC layer(s) may be provided (doped) with one or more metal elements (sometimes referred to herein as metal dopants) during deposition. The metal dopants may serve to minimize the electrical resistance and thus maximize the electrical conductivity of coating 36, thereby allowing substrate 35 to convey electrical signals (e.g., power signals) with another conductive structure through coating 36 (e.g., in implementations where substrate 35 is formed from charging port 29, conductive contacts 31, and/or plug 32 of FIG. 2). As one example, the DLC layer(s) may be deposited in coating 36 using a plasma-assisted chemical vapor deposition process and the metal dopants may be sputtered directly into the DLC layer(s) during deposition. There may be one, two, three, or more than three metal dopants (e.g., different metal elements) in the DLC layer(s) of thin-film interference filter 38.

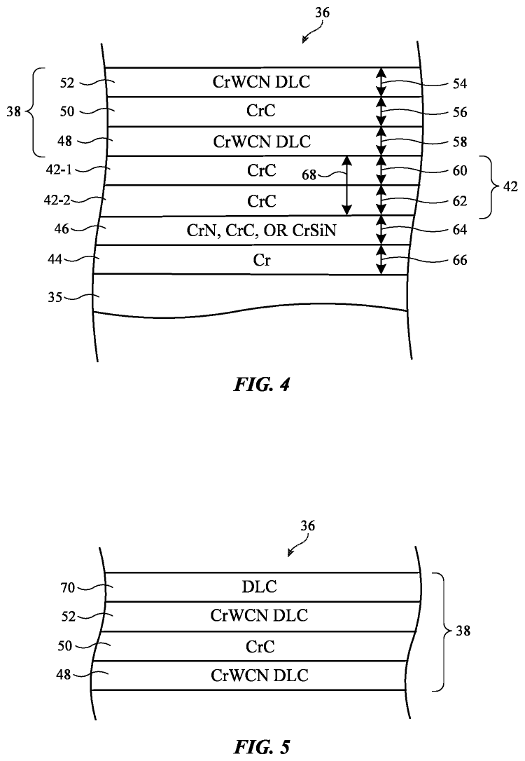

FIG. 4 is a cross-sectional side view of coating 36 in one example where thin-film interference filter 38 has two DLC layers that each include nitrogen and two metal dopants. As shown in FIG. 4, adhesion and transition layers 40 may include a seed (adhesion) layer 44 on substrate 35 and one or more transition layers such as transition layer 46 on seed layer 44. Seed layer 44 may couple substrate 35 to transition layer 46 (e.g., transition layer 46 may be interposed between seed layer 44 and opaque coloring layer 42).

In the example of FIG. 4, seed layer 44 is formed from chromium (Cr) and may therefore sometimes be referred to herein as Cr layer 44 or Cr seed layer 44. Transition layer 46 may be formed from chromium nitride (CrN), chromium carbide (CrC), or chromium silicon nitride (CrSiN). Transition layer 46 may sometimes be referred to herein as CrN layer 46 when the transition layer includes CrN, as CrSiN layer 46 when the transition layer includes CrSiN, or as CrC layer 46 when the transition layer 46 includes CrC. This is merely illustrative. In general, seed layer 44 and/or transition layer 46 may include chromium nitride (CrN), chromium silicon (CrSi), titanium (Ti), chromium silicon nitride (CrSiN), chromium silicon carbonitride (CrSiCN), chromium silicon carbide (CrSiC), chromium carbonitride (CrCN), chromium (Cr), combinations of these, other metals, metal alloys, and/or other materials.

Seed layer 44 may have a thickness 66. Thickness 66 may be, for example, 0.1-1.0 microns, 0.1-0.5 microns, 0.05-0.75 microns, 0.2-0.3 microns, 0.1-10 microns, 0.1-0.5 microns, 0.1-1 microns, 0.2-0.5 microns, 0.3-0.4 microns, or other thicknesses. Transition layer 46 may have a thickness 64. Thickness 64 may be, for example, 0.1-1.0 microns, 0.1-0.5 microns, 0.05-0.75 microns, 0.3-0.8 microns, 0.4-2 microns, 0.05-0.7 microns, 0.1-5 microns, 0.2-0.9 microns, 0.3-0.4 microns, 1-2 microns, or other thicknesses (e.g., greater than thickness 66).

In the example of FIG. 4, thin-film interference filter 38 is a three-layer interference filter having a first layer 48, a second layer 50 on layer 48, and a third layer 52 on layer 50. First layer 48 may be a lowermost (bottom) layer of thin-film interference filter 38 that is layered onto opaque color layer(s) 42 (or onto transition layer 46 when opaque color layer(s) 42 are omitted). Second layer 50 may be a middle layer of thin-film interference filter 38 that is layered onto first layer 48. Third layer 52 may be an uppermost (top) layer of thin-film interference filter 38 that is layered onto second layer 50.

As shown in FIG. 4, coating 36 may include two opaque color layers 42-1 and 42-2 (having respective thicknesses 60 and 62) or a single opaque color layer 42 having thickness 68. Opaque color layers 42 (e.g., opaque color layers 42-1 and 42-2) may include CrC, as one example, and may therefore sometimes also be referred to herein as CrC layers 42. In implementations where coating 36 includes two opaque color layers 42-1 and 42-2, opaque color layer 42-2 may be deposited using a first deposition process such as a high impulse magnetron sputtering (HiPIMS) process whereas opaque color layer 42-1 is deposited using a second deposition process such as a magnetron sputtering (MS) process. Alternatively, opaque color layers 42 may be omitted from coating 36.

Thickness 60 may be, for example, 0.2-0.3 microns, 0.1-0.5 microns, 0.05-0.75 microns, 0.05-1.0 microns, greater than 0.2 microns, greater than 0.1 microns, less than 0.3 microns, less than 0.4 microns, or other thicknesses. Thickness 62 may be, for example, 0.2-0.3 microns, 0.1-0.5 microns, 0.05-0.75 microns, 0.05-1.0 microns, greater than 0.2 microns, greater than 0.1 microns, less than 0.3 microns, less than 0.4 microns, or other thicknesses (e.g., equal to thickness 60 or different from thickness 60). Thickness 60 (e.g., in implementations where coating 36 includes a single opaque color layer 42) may be, for example, 0.3-0.5 microns, 0.2-0.6 microns, 0.05-0.75 microns, 0.05-1.0 microns, 0.05-0.2 microns, greater than 0.1 microns, greater than 0.2 microns, less than 0.6 microns, less than 0.7 microns, or other thicknesses (e.g., greater than thicknesses 60 and 62).

Layer 48 may have thickness 58. Layer 50 may have thickness 56. Layer 52 may have thickness 54. Thicknesses 54, 56, and 58 and the compositions of layers 48, 50, and 52 may be selected to impart thin-film interference filter 38 with desired interference effects to transmitted and reflected light, thereby configuring coating 36 to reflect visible light with a desired visible color response. Thickness 54 may be, for example, 60-70 nm, 50-80 nm, 40-90 nm, 55-75 nm, 20-100 nm, greater than 50 nm, greater than 60 nm, less than 70 nm, less than 80 nm, less than 100 nm, or other thicknesses. Thickness 56 may be, for example, 10-20 nm, 1-30 nm, 5-25 nm, 12-19 nm, 8-22 nm, greater than 10 nm, greater than 15 nm, greater than 5 nm, less than 25 nm, less than 35 nm, or other thicknesses less than thickness 54. Thickness 58 may be, for example, 50-60 nm, 40-70 nm, 30-80 nm, 50-55 nm, 46-61 nm, greater than 50 nm, greater than 40 nm, greater than 30 nm, less than 60 nm, less than 80 nm, or other thicknesses greater than thickness 56 and/or less than thickness 54.

As one example, layer 50 may include chromium carbide (CrC) and may therefore sometimes be referred to herein as CrC layer 50. Layer 52 may include DLC and may therefore sometimes be referred to herein as DLC layer 52. Layer 48 may also include DLC and may therefore sometimes be referred to herein as DLC layer 48. DLC is an amorphous, synthetic, carbon material having a relatively high number of sp³ hybridized carbon atoms (e.g., a ratio of sp³ hybridized atoms relative to other atoms that exceeds a threshold level), which imparts the material with diamond-like properties (e.g., diamond-like hardness, slickness, etc.). The DLC may also include one or more fillers (e.g., non-sp³ hybridized atoms) such as sp² hybridized carbon (e.g., graphite-like carbon) and/or hydrogen.

To minimize the electrical resistivity and maximize the electrical conductivity of thin-film interference filter 38 and thus coating 36, DLC layers 52 and 48 may each include metal dopants such as at least a first metal dopant and a second metal dopant. The metal dopants may include any desired metal elements/atoms (e.g., tungsten, chromium, titanium, silver, gold, copper, aluminum, nickel, iron, tin, zinc, lead, cobalt, manganese, sodium, lithium, platinum, barium, indium, magnesium, vanadium, mercury, niobium, potassium, calcium, etc.). In the example of FIG. 4, the first metal dopant is chromium (Cr) and the second metal dopant is tungsten (W). Both DLC layers 52 and 48 may include chromium and tungsten dopants or, if desired, DLC layer 52 may include one or more different dopants than those in DLC layer 48. In addition to carbon (C) and the first and second metal dopants, DLC layers 52 and 48 may also include nitrogen (N). In other words, DLC layers 52 and 48 may include CrWCN (e.g., where the carbon is DLC) and may therefore sometimes also be referred to herein as CrWCN layers 52 and 48 or CrWCN DLC layers 52 and 48 (or equivalently as WCrCN DLC layers 52 and 48).

When configured in this way, coating 36 may exhibit a desired color response (e.g., a dark black, grey, and/or blue color response) across a range of different coating thicknesses (e.g., as given by the underlying geometry of substrate 35) at a corresponding range of viewing angles, while also exhibiting a sufficient level of corrosion resistance and a sufficient level of electrical conductivity to allow substrate 35 to convey electrical signals (e.g., power) with another conductive structure through coating 36.

The example of FIG. 4 is merely illustrative. In a first exemplary implementation, thin-film interference filter 38 includes layers 48-52, coating 36 includes opaque coloring layers 42-1 and 42-2 (e.g., CrC layers), transition layer 46 is a CrN transition layer, and seed layer 44 is a Cr transition layer. In a second exemplary implementation, thin-film interference filter 38 includes layers 48-52, coating 36 includes a single opaque coloring layer 42 (e.g., a CrC layer), transition layer 46 is a CrN transition layer, and seed layer 44 is a Cr transition layer. In a third exemplary implementation, thin-film interference filter 38 includes layers 48-52, coating 36 includes no opaque coloring layers 42, transition layer 46 is a CrC transition layer, and seed layer 44 is a Cr transition layer.

In a fourth exemplary implementation, thin-film interference filter 38 includes layers 48-52, seed layer 66 includes chromium silicide (CrSi), transition layer 46 includes CrSiN, and coating 36 includes a single opaque color layer 42 (e.g., a CrC layer). In a fifth exemplary implementation, coating 36 includes layers 48-52, seed layer 66 includes CrSi, transition layer 46 includes CrSiN, and coating 36 does not include any opaque color layers 42. In a sixth exemplary implementation, coating 36 includes layers 48-52, seed layer 66 is a Cr layer, transition layer 46 is a CrN layer, and coating 36 includes a single opaque color layer 42 (e.g., a CrC layer). In a seventh exemplary implementation, coating 36 includes layers 48-52, seed layer 66 is a Cr layer, transition layer 46 is a CrN layer, and coating 36 includes a two opaque color layers 42-1 and 42-2 (e.g., CrC layers). Coating 36 may include other arrangements if desired.

The example of FIG. 4 in which thin-film interference filter 38 includes two DLC layers 48 and 52 is illustrative and non-limiting. If desired, thin-film interference filter 38 may include an additional DLC layer 70 layered onto DLC layer 52, as shown in the example of FIG. 5. In the example of FIG. 5, the layers below thin-film interference filter 38 have been omitted for the sake of clarity. As shown in FIG. 5, DLC layer 70 may form the uppermost of thin-film interference filter 38 and coating 36. DLC layer 70 may, for example, be a carbon flash coating that is deposited using a lower bias voltage setting than DLC layer 52 (e.g., during magnetron sputtering). DLC layer 70 may include nitrogen and one, two, three, or more than three metal dopants (e.g., Cr and W, the same metal dopants as layers 52 and/or 48, different metal dopants than layers 52 and 48, etc.).

If desired, thin-film interference filter 38 may include only a single DLC layer. For example, in an eighth exemplary implementation of the coating 36 shown in FIG. 4, thin-film interference filter 38 may include only layers 50 and 52, DLC layer 48 may form an opaque color layer 42 instead of a part of thin-film interference filter 38, transition layer 46 may include CrC, and seed layer 44 may include Cr.

FIG. 6 shows one example of coating 36 in an example where coating 36 includes a single DLC layer 48 layered onto transition layer 46 (e.g., DLC layer 48 may be the only DLC layer in coating 36). Transition layer 46 may include CrC and seed layer 44 may include Cr, as one example. DLC layer 48 may form a single-layer thin-film interference filter (e.g., thin-film interference filter 38 of FIG. 3) or may form an opaque color layer 42 in coating 36. DLC layer 48 may include two metal dopants (e.g., Cr and W). The thickness of DLC layer 48 may be 1-7 microns, 3-7 microns, 3-4 microns, greater than 1 micron, greater than 2 microns, greater than 0.5 microns, less than 7 microns, less than 6 microns, less than 5 microns, less than 4 microns, or other thicknesses in this example.

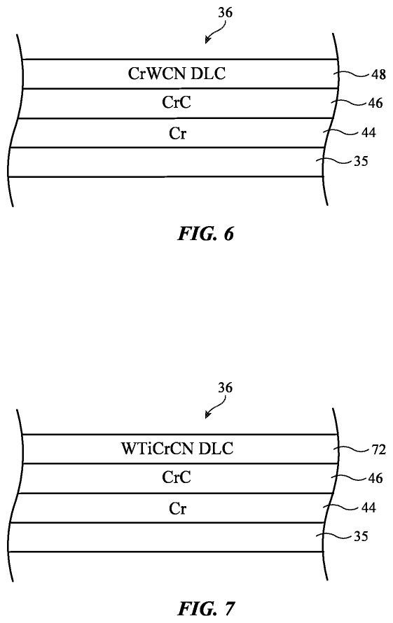

If desired, one or more of the DLC layers in coating 36 (e.g., DLC layer 52 and/or DLC layer 48 in FIGS. 4-6 and/or DLC layer 70 in FIG. 5) may include three different metal dopants. FIG. 7 shows one example of coating 36 in an example where coating 36 includes a single DLC layer 72 layered onto transition layer 46 (e.g., DLC layer 72 may be the only DLC layer in coating 36), where DLC layer 72 has three metal dopants. DLC layer 72 may, for example, be doped with W, Ti, and Cr and may include C (e.g., DLC) and N. DLC layer 72 is sometimes also referred to herein as WTiCrCN layer 72 (or equivalently TiCrWCN layer 72, WCrTiCN layer 72, or TiWCrCN layer 72) or WTiCrCN DLC layer 72. The thickness of DLC layer 72 may be 5-7 microns, 3-9 microns, 4-8 microns, 0.5-10 microns, greater than 1 micron, greater than 3 microns, greater than 5 microns, less than 7 microns, less than 8 microns, less than 10 microns, or other thicknesses in this example. The bi-metallic doped DLC layer 48 in FIG. 6 may, for example, configure coating 36 to exhibit a slightly higher L* value but a slightly higher electrical resistance than the tri-metallic doped DLC layer 72 in FIG. 7.

When configured in this way (e.g., using the stacked layers as shown and described in connection with any of FIGS. 4-7), coating 36 may exhibit a dark black, grey, and/or blue color response. For example, at a location along the lateral area of coating 36 at which coating 36 exhibits peak thickness, when viewed at an angle of zero degrees relative to a normal axis/surface of the lateral area of coating 36, coating 36 may exhibit an L* value (in an L*a*b* color space) of greater than 40, greater than 35, greater than 30, 35-45, 30-50, 35-50, or other L* values, an a* value (in the L*a*b* color space) of −5-5, −2-5, −1-1, −0.5-0.5, −10-10, 0-1.0, greater than −1, greater than −2, greater than −5, less than 1, less than 2, less than 5, or other a* values, and a b* value (in the L*a*b* color space) of −5-0, −3-1, −5-5, −10-10, greater than −5, greater than −3, greater than −10, less than 0, less than −1, less than 1, less than 5, less than 10, or other b* values.

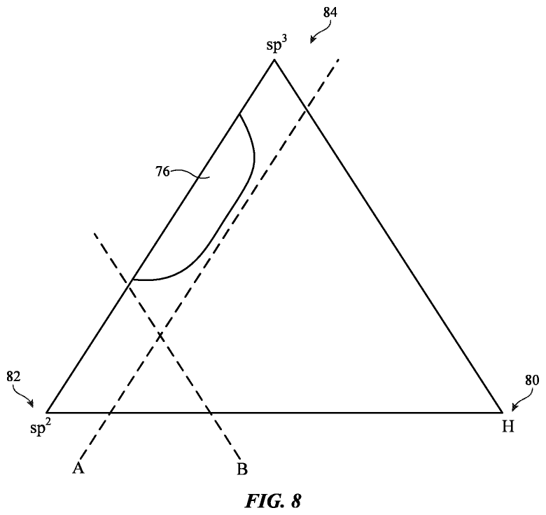

FIG. 8 is a ternary phase diagram of the DLC layer(s) in coating 36 (e.g., DLC layers 52 and/or 48 of FIGS. 4-6 and/or DLC layer 72 of FIG. 7). As shown in FIG. 8, the relative composition of the DLC layer(s) may be plotted on a ternary phase diagram having a first corner 84 corresponding to pure diamond-like carbon (e.g., pure sp³ hybridized carbon), a second corner 82 corresponding to pure graphite-like carbon (e.g., pure sp² hybridized carbon), and a third corner 80 corresponding to pure hydrocarbons. As hydrocarbons are added to pure graphite-like carbon, the composition (phase) moves away from corner 82 along the horizontal axis towards corner 80, as diamond-like carbon is added to pure graphite-like carbon, the composition moves away from corner 82 along the first diagonal axis towards corner 84, as hydrocarbons are added to pure diamond-like carbon, the composition moves away from corner 84 along the second diagonal axis towards corner 80, etc. Corner 82 may correspond to a composition that is more electrically conductive than corner 84.

To optimize the optical, corrosive, and/or electrical performance of coating 36, the DLC layer(s) 50 may be provided with a relatively high ratio of sp³ hybridized carbon relative to sp² hybridized carbon and with a relatively high ratio of sp³ hybridized carbon relative to hydrocarbons. For example, the DLC layer(s) may be provided with a composition that lies within region 76 of the ternary phase diagram of FIG. 8. In other words, DLC layer 50 may be provided with a composition having a ratio of sp³ hybridized carbon to sp² hybridized carbon that exceeds threshold level B and having a ratio of sp³ hybridized carbon to hydrocarbons that exceeds threshold level A (e.g., region 76 may lie above thresholds A and B). Threshold A may be 50%, 60%, 70%, 80%, 90%, 95%, more than 50%, more than 40%, more than 60%, more than 70%, more than 80%, more than 90%, more than 95%, or other values. Threshold B may be 50%, 60%, 70%, 80%, 90%, 95%, more than 50%, more than 40%, more than 60%, more than 70%, more than 80%, more than 90%, more than 95%, or other values. Region 76 may have other shapes in practice.

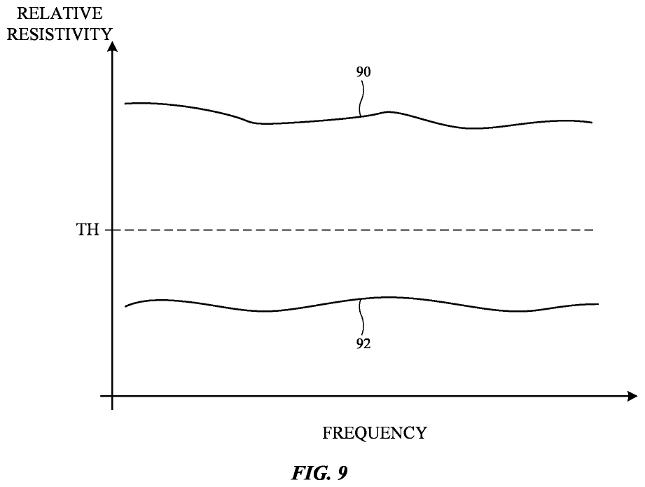

FIG. 9 is a diagram that plots the relative electrical resistivity of coating 36 (e.g., on a logarithmic scale) as a function of the frequency (e.g., on a logarithmic scale) of electrical signals (e.g., power signals) conveyed by the underlying substrate 35 through coating 36. As shown in FIG. 9, curve 90 plots the resistivity of coating 36 when the DLC layer(s) in the coating do not include any metal dopants. Curve 92 plots the resistivity of coating 36 when the DLC layer(s) include at least two metal dopants (e.g., Cr and W as shown in FIGS. 4-6 or Cr, W, and Ti as shown in FIG. 7).

In general, higher relative resistivity corresponds to lower electrical conductivity and lower relative resistivity corresponds to higher electrical conductivity. Threshold TH corresponds to the maximum electrical resistivity (minimum electrical conductivity) that coating 36 can exhibit while still allowing the underlying substrate 35 to convey electrical signals with another conductive structure at or through coating 36 (e.g., with a satisfactory level of electrical performance). As shown by curve 90, when the DLC layer(s) are deposited without metal dopants, the resistivity of coating 36 exceeds threshold TH and thus the coating is not sufficiently conductive to convey electrical signals for substrate 35. On the other hand, as shown by curve 92, the inclusion of metal dopants in the DLC layer(s) causes the coating to exhibit a resistivity less than threshold TH, thereby configuring coating 36 to be sufficiently conductive to convey electrical signals for substrate 35 (e.g., without deteriorating the electrical performance of substrate 35 and/or the external conductive structure).

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. Apparatus comprising:
a conductive substrate; and
a coating on the conductive substrate and having a color, the coating comprising:
adhesion and transition layers, and
a diamond-like carbon (DLC) layer on the adhesion and transition layers, wherein the DLC layer comprises a metal dopant.

2. The apparatus of claim 1, wherein the metal dopant comprises tungsten or chromium.

3. The apparatus of claim 1, wherein the DLC layer comprises an additional metal dopant different from the metal dopant.

4. The apparatus of claim 3, wherein the metal dopant comprises tungsten and the additional metal dopant comprises chromium.

5. The apparatus of claim 4, further comprising a titanium dopant in the DLC layer.

6. The apparatus of claim 4, wherein the DLC layer further comprises nitrogen.

7. The apparatus of claim 1, wherein the DLC layer is an uppermost layer of the coating.

8. The apparatus of claim 7, the coating further comprising:
a chromium carbide (CrC) layer between the DLC layer and the adhesion and transition layers; and
an additional DLC layer between the CrC layer and the adhesion and transition layers.

9. The apparatus of claim 8, wherein the additional DLC layer comprises the metal dopant.

10. The apparatus of claim 8, the coating further comprising:
an opaque layer between the additional DLC layer and the adhesion and transition layers.

11. The apparatus of claim 10, wherein the opaque layer comprises CrC.

12. The apparatus of claim 11, the coating further comprising:
an additional opaque layer between the opaque layer and the adhesion and transition layers, the additional opaque layer comprising CrC.

13. The apparatus of claim 8, wherein the adhesion and transition layers comprise a chromium seed layer and a transition layer that comprises chromium nitride (CrN), CrC, or chromium silicon nitride (CrSiN).

14. The apparatus of claim 8, the coating further comprising:
a further DLC layer between the CrC layer and the DLC layer.

15. The apparatus of claim 1 wherein, at a location of maximum thickness and a viewing angle of zero degrees relative to a normal axis of the coating, the coating has an L* value greater than 30, an a* value between −10 and 10, and a b* value between −10 and 10.

16. Apparatus comprising:
a conductive substrate; and
a coating on the conductive substrate and having a color, the coating comprising:
adhesion and transition layers, and
a thin-film interference filter on the adhesion and transition layers, the thin-film interference filter having a layer that includes diamond-like carbon (DLC), a first metal, a second metal, and nitrogen.

17. The apparatus of claim 16, wherein the first metal comprises tungsten and the second metal comprises chromium.

18. The apparatus of claim 16, the thin-film interference filter further comprising:
a DLC layer between the layer and the adhesion and transition layers; and
a chromium carbide (CrC) layer between the layer and the DLC layer.

19. An electronic device comprising:
a conductive contact configured to convey power signals; and
a coating on the conductive contact and having a color, the coating comprising:
adhesion and transition layers on the conductive contact,
a first diamond-like carbon (DLC) layer on the adhesion and transition layers,
a chromium carbide (CrC) layer on the first DLC layer, and
a second DLC layer on the CrC layer, wherein the first DLC layer and the second DLC layer are each doped with a first metal and a second metal different from the first metal.

20. The electronic device of claim 19, wherein the electronic device comprises a charger configured to deliver the power signals to an external device.
